(19) United States
(12) Patent Application Publication
(10) Pub. No.: US 2023/0176532 A1
(43) Pub. Date: Jun. 8, 2023

(54) CONTROL ASSIST DEVICE, CONTROL DEVICE, AND CONTROL ASSIST METHOD

(71) Applicant: FANUC CORPORATION, Minamitsuru-gun, Yamanashi (CN)

(72) Inventor: Ryoutarou TSUNEKI, Yamanashi (JP)

(21) Appl. No.: 17/926,373

(22) PCT Filed: Jun. 2, 2021
(86) PCT No.: PCT/JP2021/020938

§ 371 Date: Nov. 18, 2022

(30) Foreign Application Priority Data
Jun. 9, 2020 (JP) 2020-099963

(51) Int. Cl. G05B 13/02

(52) U.S. Cl. CPC G05B 13/024

(57) ABSTRACT

A control assist device according to the present invention uses first information and second information, which comprise at least one filter coefficient of a servo control device that controls a motor and/or feedback gain, prior to or after being adjusted, calculates at least one frequency characteristic from among input/output gain between filter and feedback gain, and phase lag, prior to or after the filter coefficient and/or feedback gain is adjusted, and obtains an estimated frequency characteristic value for the servo control device input/output gain and phase lag after the filter coefficient and/or feedback gain is adjusted, on the basis of at least one frequency characteristic prior to or after being adjusted and the measured frequency characteristics of servo control device input/output gain and phase lag prior to the coefficient and/or feedback gain being adjusted.

### TECHNICAL FIELD

The present invention relates to a control assist device configured to adjust at least either of at least one coefficient of a filter and feedback gain (FG) of a servo control unit configured to control a motor, a control device including the control assist device and a servo control device, and a control assist method.

### BACKGROUND ART

Patent Document 1, for example, describes a control system and a control assist device achieving setting of appropriate control conditions for servos within a short period of time. The control system described in Patent Document 1 includes: a servo system configured to control a motor configured to drive a load device; and a control assist device coupled to the servo system and configured to automatically adjust an optimum value for an adjustment parameter to be set for controlling the motor to perform predetermined target operation. An adjustment parameter adjustment unit in the control assist device is configured to automatically set a parameter that should be adjusted and its adjustment range based on a simulation result and to automatically adjust an optimum value for the adjustment parameter within the adjustment range based on a result of actual operation of the motor.

Furthermore, Patent Document 2, for example, describes a travel control setting device for a vehicle, which makes it possible to easily set a control parameter within a short period of time for feedback control of a drive motor. The travel control setting device for a vehicle described in Patent Document 2 is a travel control setting device for a vehicle in which, when a transport vehicle that travels in an automated manner is under a travel control along a predetermined travel route, a motor for travel-driving undergoes a feedback control to attain a predetermined speed of rotation; its operation characteristics are estimated as a model formula indicating a transfer function based on an operation state of the motor, which is to be acquired when the transport vehicle is under test traveling; and control gain for feedback control is determined based on the estimated model formula.

Furthermore, Patent Document 3, for example, describes an automatic gain adjustment assist device configured to assist an automatic adjustment of control gain of a control loop in a servo motor control device. The automatic gain adjustment assist device described in Patent Document 3 includes: a frequency characteristics measurement unit configured to measure frequency characteristics of a control loop in the servo motor control device; a display unit configured to display the frequency characteristics of the control loop in a Bode plot; a condition setting unit configured to set a target gain value at a predetermined frequency; an automatic gain adjustment unit configured to automatically adjust control gain of the control loop to allow the control gain to coincide with the target gain value at the predetermined frequency, which has been set by the condition setting unit; and a parameter setting unit configured to set the control gain in the servo motor control device.
Patent Document 1: Japanese Unexamined Patent Application, Publication No. 2009-122779
Patent Document 2: Japanese Unexamined Patent Application, Publication No. H11-194821
Patent Document 3: Japanese Unexamined Patent Application, Publication No. 2016-092935

### DISCLOSURE OF THE INVENTION

### Problems to be Solved by the Invention

When adjusting at least either of at least one coefficient of a filter and feedback gain of a servo control device to allow frequency characteristics of input/output gain (amplitude ratio) and phase lag of the servo control device configured to control a motor to attain respective target frequency characteristics, it has been necessary to allow the servo control device to operate each time adjusting at least either of the at least one coefficient of the filter and the feedback gain to acquire the frequency characteristics of input/output gain and phase lag. However, allowing the servo control device to operate each time adjusting at least either of the at least one coefficient of the filter and the feedback gain to measure the frequency characteristics of input/output gain and phase lag requires a certain period of time. What is demanded is to shorten this period of time to as short as possible.

### Means for Solving the Problems

(1) A first aspect of the present disclosure is directed to a control assist device configured to provide assistance for performing an adjustment of at least either of at least one coefficient of a filter and feedback gain of a servo control device configured to control a motor. The control assist device includes:

a servo state information acquisition unit configured to acquire first information including at least either of the at least one coefficient of the filter and the feedback gain after the adjustment;
a frequency characteristics calculation unit configured to use second information including at least either of the at least one coefficient of the filter and the feedback gain before the adjustment and the first information and to calculate at least one of frequency characteristics among frequency characteristics of input/output gain and phase lag of the filter and frequency characteristics of input/output gain and phase lag of the feedback gain before and after the adjustment of the coefficient of the filter and the feedback gain; and a state estimation unit configured to acquire, based on the at least one of frequency characteristics before and after the adjustment and measured frequency characteristics of input/output gain and phase lag in input/output of the servo control device before the adjustment of at least either of the coefficient of the filter and the feedback gain, estimation values of the frequency characteristics of input/output gain and phase lag of the servo control device after the adjustment of at least either of the coefficient of the filter and the feedback gain.

(2) A second aspect of the present disclosure is directed to a control device including:

a servo control device configured to control a motor; and the control assist device described above in (1) configured to acquire estimation values of the frequency characteristics of input/output gain and phase lag of the servo control device after adjustment of at least either of at least one coefficient of the filter and the feedback gain of the servo control device.

(3) A third aspect of the present disclosure is directed to a control assist method for a control assist device configured to provide assistance for performing an adjustment of at least either of at least one coefficient of a filter and feedback gain of a servo control device configured to control a motor. The control assist method includes:

acquiring first information including at least either of the at least one coefficient of the filter and the feedback gain after the adjustment and second information including at least either of the at least one coefficient of the filter and the feedback gain before the adjustment;
using the second information and the first information to calculate at least one of frequency characteristics among frequency characteristics of input/output gain and phase lag of the filter and frequency characteristics of input/output gain and phase lag of the feedback gain before and after the adjustment of at least either of the coefficient of the filter and the feedback gain; and
acquiring, based on the at least one of frequency characteristics before and after the adjustment and measured frequency characteristics of input/output gain and phase lag in input/output of the servo control device before the adjustment of at least either of the coefficient of the filter and the feedback gain, estimation values of the frequency characteristics of input/output gain and phase lag of the servo control device after the adjustment of at least either of the coefficient of the filter and the feedback gain.

### Effects of the Invention

According to the aspects of the present disclosure, when adjusting at least either of at least one coefficient of the filter and feedback gain of the servo control device, it is possible to estimate frequency characteristics of input/output gain and phase lag without acquiring frequency characteristics of input/output gain and phase lag by allowing the servo control device to operate each time adjusting at least either of the at least one coefficient of the filter and the feedback gain. Therefore, it is possible to shorten the period of time it takes to measure frequency characteristics of input/output gain and phase lag.

### BRIEF DESCRIPTION OF THE DRAWINGS

FIG. 1 is a block diagram illustrating a control device according to a first embodiment of the present disclosure;

FIG. 2 is a flowchart illustrating operation of a control assist device illustrated in FIG. 1;

FIG. 3 is a block diagram illustrating a control device according to a second embodiment of the present disclosure;

FIG. 4 is a block diagram illustrating a control device according to a third embodiment of the present disclosure;

FIG. 5 is a block diagram illustrating a machine learning unit according to an embodiment of the present invention;

FIG. 6 is a block diagram illustrating a model used to calculate a reference model of input/output gain;

FIG. 7 is a characteristic diagram illustrating frequency characteristics of input/output gain of a servo control unit, according to the reference model, and frequency characteristics according to estimation values of input/output gain of a servo control unit 100 before learning and after learning;

FIG. 8 is a view illustrating frequency characteristics according to estimation values of input/output gain and phase lag;

FIG. 9 is a block diagram illustrating an example when configuring a filter by directly coupling a plurality of filters to each other; and

FIG. 10 is a block diagram illustrating another configuration example of a control device.

### PREFERRED MODE FOR CARRYING OUT THE INVENTION

Embodiments of the present disclosure will now be described herein in detail with reference to the accompanying drawings.

### First Embodiment

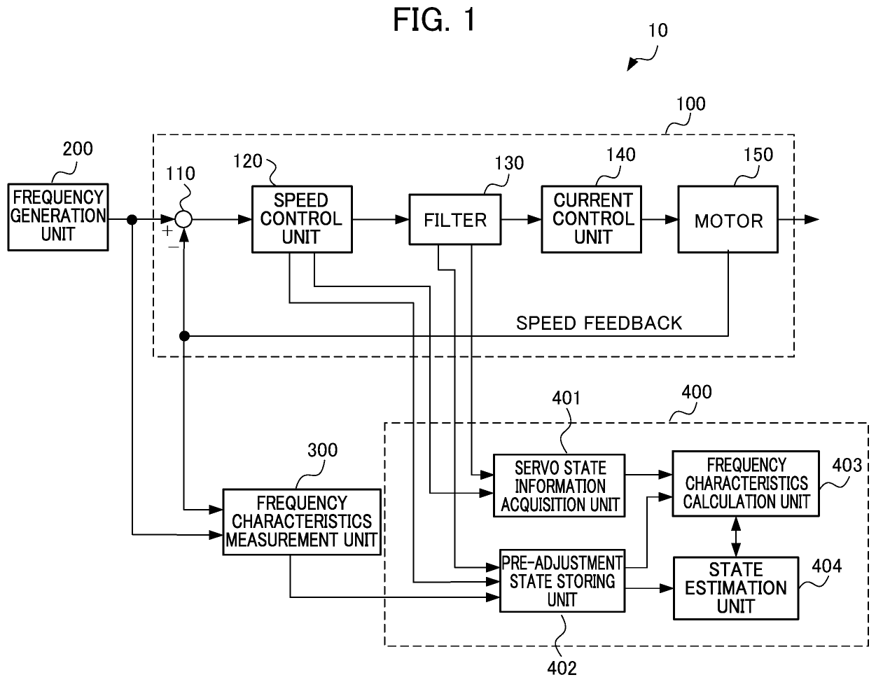

FIG. 1 is a block diagram illustrating a control device according to a first embodiment of the present disclosure. A control device 10 includes a servo control unit 100, a frequency generation unit 200, a frequency characteristics measurement unit 300, and a control assist unit 400. The servo control unit 100 corresponds to a servo control device configured to control a motor. The frequency characteristics measurement unit 300 corresponds to a frequency characteristics calculation device. The control assist unit 400 corresponds to a control assist device. Note that one or more of the frequency generation unit 200, the frequency characteristics measurement unit 300, and the control assist unit 400 may be provided in the servo control unit 100. The frequency characteristics measurement unit 300 may be provided in the control assist unit 400.

The servo control unit 100 includes a subtracter 110, a speed control unit 120, a filter 130, a current control unit 140, and a motor 150. The subtracter 110, the speed control unit 120, the filter 130, the current control unit 140, and the motor 150 configure a servo system of a speed feedback loop constituting a closed loop. As the motor 150, it is possible to use a linear motor that performs linear motions or a motor having a rotation shaft, for example. A target to be driven by the motor 150 is, for example, a mechanical part of a machine tool, a robot, or an industrial machine. The motor 150 may be provided as a part of a machine tool, a robot, or an industrial machine, for example. The control device 10 may be provided as a part of a machine tool, a robot, or an industrial machine, for example.

The subtracter 110 is configured to acquire a difference between an inputted speed command and a detected speed that has been provided as speed feedback, and to output the difference as a speed error to the speed control unit 120.

The speed control unit 120 is configured to perform proportional-integral control (PI control), to add an integrated value acquired by multiplying the speed error by integral gain K1v and a value acquired by multiplying the speed error by proportional gain K2v, and to output the acquired value to the filter 130 as a torque command. The speed control unit 120 contains feedback gain (FG). Note that what the speed control unit 120 performs is not particularly limited to the PI control, but may use another control such as proportional-integral-differential control (PID control). Mathematical Equation 1 (hereinafter referred to as Equation 1) represents a transfer function G_{V}(s) of the speed control unit 120.

$${G}_{V} ( s ) = \frac{K 1 v}{s} + K 2 v \qquad [ Equation 1 ]$$

For the filter 130, a filter configured to attenuate certain frequency components such as a notch filter, a low-pass filter, or a band-stop filter is used. In a machine such as a machine tool including a mechanical part that the motor 150 drives, a resonance point exists, possibly resulting in increased resonance in the servo control unit 100. By using a filter such as a notch filter, it is possible to reduce resonance. An output of the filter 130 is outputted as a torque command to the current control unit 140. Mathematical Equation 2 (hereinafter referred to as Equation 2) represents a transfer function G_{F}(s) of a notch filter serving as the filter 130. Note herein that, in Mathematical Equation 2, a coefficient δ represents an attenuation coefficient, a coefficient ω_{c} represents a center angle frequency, and a coefficient T represents a fractional bandwidth. When a center frequency is represented by fc, and a bandwidth is represented by fw, the coefficient ω_{c} is represented by ω_{c}=2πfc, and the coefficient τ is represented by τ=fw/fc.

$${G}_{F} ( s ) = \frac{{s}^{2} + 2 δ τ {ω}_{c} s + {ω}_{c}^{2}}{{s}^{2} + 2 τ {ω}_{c} s + {ω}_{c}^{2}} \qquad [ Equation 2 ]$$

The current control unit 140 is configured to generate a voltage command for driving the motor 150 based on the torque command, and to output the voltage command to the motor 150. When the motor 150 is a linear motor, the position of a movable part is detected by a linear scale (not shown) provided in the motor 150. A position detection value is then differentiated to acquire a speed detection value. The acquired speed detection value is inputted into the subtracter 110 as speed feedback. When the motor 150 is a motor including a rotation shaft, a rotation angle position is detected by a rotary encoder (not shown) provided in the motor 150. A speed detection value is then inputted into the subtracter 110 as speed feedback.

The servo control unit 100 is constructed as described above. However, in order to acquire estimation values of frequency characteristics of input/output gain and phase lag of the servo control unit 100 after adjustment of one or both of the integral gain K1v and the proportional gain K2v and/or each of the coefficients ω_{c}, τ, and δ of the transfer function of the filter 130, the control device 10 further includes the frequency generation unit 200, the frequency characteristics measurement unit 300, and the control assist unit 400.

The frequency generation unit 200 is configured to output a sinusoidal signal, while sequentially changing a frequency, as a speed command to the subtracter 110 of the servo control unit 100 and the frequency characteristics measurement unit 300.

The frequency characteristics measurement unit 300 is configured to use a speed command (a sinusoidal wave) serving as an input signal generated by the frequency generation unit 200 and a detected speed (a sinusoidal wave) serving as an output signal outputted from the rotary encoder (not shown), and to measure, per frequency specified by the speed command, an amplitude ratio (input/output gain) and phase lag between the input signal and the output signal. Otherwise, the frequency characteristics measurement unit 300 uses a speed command (a sinusoidal wave) serving as an input signal generated by the frequency generation unit 200 and a differential (a sinusoidal wave) of a detection position, which serves as an output signal outputted from the linear scale, and measures, per frequency specified by the speed command, an amplitude ratio and phase lag between the input signal and the output signal.

The servo control unit 100 operates with the integral gain K1v and the proportional gain K2v of the speed control unit 120 and each of the coefficients ω_{c}, τ, and δ (hereinafter referred to as “servo parameters”) of the transfer function of the filter 130, before adjustment of one or both of the integral gain K1v and the proportional gain K2v and/or each of the coefficients ω_{c}, τ, and δ of the transfer function of the filter 130, and inputs a detected speed or a differential of a detection position described above into the frequency characteristics measurement unit 300. The frequency characteristics measurement unit 300 measures frequency characteristics P of an amplitude ratio (input/output gain) and phase lag between the speed command serving as an input signal and the output signal and outputs the measured frequency characteristics to the control assist unit 400. Servo parameters before adjustment will be hereinafter referred to as “pre-adjustment servo parameters”. Servo parameters when one or both of the integral gain K1v and the proportional gain K2v and/or each of the coefficients ω_{c}, τ, and δ of the transfer function of the filter 130 is or are adjusted, for the pre-adjustment servo parameters, will be hereinafter referred to as “post-adjustment servo parameters”.

The control assist unit 400 is configured to store the frequency characteristics P of input/output gain (amplitude ratio) and phase lag, which are outputted from the frequency characteristics measurement unit 300 as the servo control unit 100 operates with the pre-adjustment servo parameters. The control assist unit 400 uses gain, that is, either or both of the integral gain K1v and the proportional gain K2v, of the speed control unit 120 and/or each of the coefficients ω_{c}, τ, and δ of the transfer function of the filter 130 in the pre-adjustment servo parameters (serving as second information) and calculates frequency characteristics C₂ of input/output gain and phase lag of the speed control unit 120 or/and the filter 130. Furthermore, the control assist unit 400 uses gain, that is, either or both of the integral gain K1v and the proportional gain K2v, of the speed control unit 120 and/or each of the coefficients ω_{c}, τ, and δ of the transfer function of the filter 130 in the post-adjustment servo parameters (serving as first information) and calculates frequency characteristics C₁ of input/output gain and phase lag of the speed control unit 120 or/and the filter 130. Then, the control assist unit 400 acquires, based on the frequency characteristics C₁, the frequency characteristics C₂, and the frequency characteristics P, estimation values E of frequency characteristics of input/output gain and phase lag of the servo control unit 100. Specifically, Mathematical Equation 3 (hereinafter referred to as Equation 3) is used to acquire the estimation value E of frequency characteristics of input/output gain and phase lag of the servo control unit 100.

E=C₁−C₂+P [Equation 3]

Note that, although it is possible to calculate the estimation value E of frequency characteristics of input/output gain and phase lag of the servo control unit 100 by using Mathematical Equation 3 described above, that is, E=C₁−C₂+P, calculation that the control assist unit 400 performs may be one of E=(C₁−C₂)+P, E=(P−C₂)+C₁, and E=(P+C₁)−C₂. Details of the configuration and operation of the control assist unit 400 will be further described herein.

### <Control Assist Unit 400>

As illustrated in FIG. 1, the control assist unit 400 includes a servo state information acquisition unit 401, a pre-adjustment state storing unit 402, a frequency characteristics calculation unit 403, and a state estimation unit 404.

The servo state information acquisition unit 401 is configured to acquire gain, that is, either or both of the integral gain K1v and the proportional gain K2v, of the speed control unit 120 and/or each of the coefficients ω_{c}, τ, and δ of the transfer function of the filter 130 in the post-adjustment servo parameters (hereinafter referred to as first information) and to output the acquired value or values to the frequency characteristics calculation unit 403.

Note that a user should generate beforehand the pre-adjustment servo parameters. When an operator has adjusted beforehand the servo parameters, the adjusted values may serve as the “pre-adjustment servo parameters”.

The pre-adjustment state storing unit 402 is configured to store, as described above, the frequency characteristics P of input/output gain and phase lag, which are outputted from the frequency characteristics measurement unit 300. Furthermore, the pre-adjustment state storing unit 402 stores gain, that is, either or both of the integral gain K1v and the proportional gain K2v, of the speed control unit 120 and/or each of the coefficients ω_{c}, τ, and δ of the transfer function of the filter 130 in the pre-adjustment servo parameters, which is or are outputted from the speed control unit 120 and/or the filter 130 (hereinafter referred to as second information).

The frequency characteristics calculation unit 403 is configured to acquire the first information from the servo state information acquisition unit 401 and to read the second information from the pre-adjustment state storing unit 402. Then, the frequency characteristics calculation unit 403 uses a transfer function G_{V}(jω) of the speed control unit 120 and/or a transfer function G_{F}(jω) of the filter 130, which is or are included in the first information, and calculates the frequency characteristics C₁ of input/output gain and phase lag of the speed control unit 120 and/or the filter 130. Furthermore, the frequency characteristics calculation unit 403 uses the transfer function G_{V}(jω) of the speed control unit 120 and/or the transfer function G_{F}(jω) of the filter 130, which is or are included in the second information, and calculates the frequency characteristics C₂ of input/output gain and phase lag of the speed control unit 120 and/or the filter 130.

For example, frequency characteristics when the integral gain K1v and the proportional gain K2v of the transfer function G_{V}(jω) of the speed control unit 120 are multiplied by n (n represents an integer) from a value before adjustment is represented by n×G_{V}(jω) when frequency characteristics in an initial state is represented by G_{V}(jω). On a Bode plot, gain and phase are respectively represented by Mathematical Equation 4 (hereinafter referred to as Equation 4) and Mathematical Equation 5 (hereinafter referred to as Equation 5).

20 log₁₀|n×G_{V}(jω)|=20 log₁₀(n)+20 log₁₀|G_{V}(jω) [Equation 4]

tan⁻¹(n×G_{V}(jω))=tan⁻¹(G_{V}(jω)) [Equation 5]

Then, the frequency characteristics calculation unit 403 outputs the calculated frequency characteristics C₁ and the calculated frequency characteristics C₂ to the state estimation unit 404.

The state estimation unit 404 is configured to use Mathematical Equation 3 described above to acquire, based on the frequency characteristics C₁, the frequency characteristics C₂, and the frequency characteristics P, the estimation value E of frequency characteristics of input/output gain and phase lag of the servo control unit 100. A case when acquiring the estimation value E of frequency characteristics by using an equation E=(C₁−C₂)+P will now be described herein.

For example, as described above, the frequency characteristics C₁ when the integral gain K1v and the proportional gain K2v of the transfer function G_{V}(jω) of the speed control unit 120 are multiplied by n (n represents an integer) from a value before adjustment is represented by n×G_{V}(jω) when the frequency characteristics C₂ in the initial state is represented by G_{V}(jω). Frequency characteristics of gain when multiplied by n from the initial state, which are indicated by a Bode plot, will be, as illustrated in Mathematical Equation 4, frequency characteristics acquired by adding 20 log₁₀(n) to 20 log₁₀|G_{V}(jω)| representing gain in the initial state. Since frequency characteristics of phase when multiplied by n from the initial state, which are indicated by a Bode plot, are represented by tan⁻¹(n)=0, there is no change from the frequency characteristics of phase in the initial state, as illustrated in Mathematical Equation 4. Therefore, frequency characteristics multiplied by n from the initial state only change in a gain plot in the Bode plot, and 20 log₁₀(n) indicated in Mathematical Equation 3 represents a difference (C₁−C₂) between two ones of frequency characteristics, that is, the frequency characteristics multiplied by n from the initial state and the frequency characteristics in the initial state.

The state estimation unit 404 reads, from the pre-adjustment state storing unit 402, these frequency characteristics P of input/output gain and phase lag, which have been acquired by allowing the servo control unit 100 to drive by using a speed command (a sinusoidal wave) that the frequency generation unit 200 outputs, based on the pre-adjustment servo parameters, and adds a difference (C₁−C₂) to the frequency characteristics P. The frequency characteristics acquired by performing an addition lead to the estimation value E=(C₁−C₂)+P of the frequency characteristics of input/output gain and phase lag of the servo control unit 100 based on the post-adjustment servo parameters.

The embodiment described above makes it possible to calculate and acquire, within a short period of time, by using the control assist unit 400, estimation values of input/output gain and phase lag of the servo control unit 100 with the post-adjustment servo parameters, compared with a case when the servo control unit 100 is operated with the post-adjustment servo parameters, and a speed command and a detected speed are actually detected and measured by the frequency characteristics measurement unit 300.

The functional blocks included in the control device 10 have been described above. To achieve these functional blocks, the control device 10 includes an arithmetic processing device such as a central processing unit (CPU). Furthermore, the control device 10 further includes an auxiliary storage such as a hard disk drive (HDD) that stores programs for various types of control, including application software and an operating system (OS), and a main storage such as a random access memory (RAM) that stores data that the arithmetic processing unit temporarily requires to execute the programs.

In the control device 10, the arithmetic processing unit then reads the application software or the OS from the auxiliary storage, deploys the read application software or the OS into the main storage, and performs arithmetic processing on the basis of the application software or the OS. Furthermore, on the basis of a result of this arithmetic processing, various types of hardware included in the devices are controlled. Therefore, the functional blocks according to the present embodiment are achieved. That is, it is possible to achieve the present embodiment when the hardware and the software cooperate with each other.

In a case where the control assist unit 400 is expected to perform a greater amount of arithmetic processing, for example, a graphics processing unit (GPU) may be mounted on a personal computer, and a technique called general-purpose computing on graphics processing units (GPGPU) may be used to utilize the GPU in arithmetic processing, since this allows achievement of prompt processing. Furthermore, to perform more prompt processing, a plurality of computers each mounted with such a GPU as described above may be used to build a computer cluster to allow the plurality of computers included in this computer cluster to perform parallel processing.

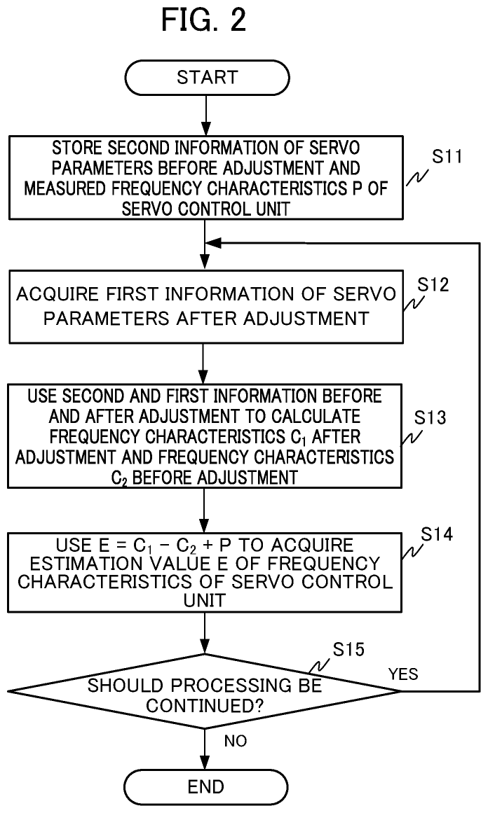

Next, operation of the control assist unit 400 will now be described herein with reference to a flowchart. FIG. 2 is a flowchart illustrating operation of the control assist device. At step S11, gain, that is, either or both of the integral gain K1v and the proportional gain K2v, of the speed control unit 120 and/or each of the coefficients ω_{c}, τ, and δ of the transfer function of the filter 130 in the pre-adjustment servo parameters is or are outputted, from the speed control unit 120 and/or the filter 130, to and stored in the pre-adjustment state storing unit 402 (second information). Note herein that a user generates beforehand the pre-adjustment servo parameters. Furthermore, at step S1l, frequency characteristics (the frequency characteristics P in FIG. 2) of input/output gain (amplitude ratio) and phase lag, which have been acquired by allowing the servo control unit 100 to drive by using a speed command (a sinusoidal wave) that the frequency generation unit 200 outputs, based on the pre-adjustment servo parameters, are acquired from the frequency characteristics measurement unit 300, and are stored in the pre-adjustment state storing unit 402.

At step S12, the servo state information acquisition unit 401 acquires and outputs, to the frequency characteristics calculation unit 403, gain, that is, either or both of the integral gain K1v and the proportional gain K2v, of the speed control unit 120 and/or each of the coefficients ω_{c}, τ, and δ of the transfer function of the filter 130 in the post-adjustment servo parameters (first information). At step S13, the frequency characteristics calculation unit 403 acquires and outputs, to the state estimation unit 404, two of frequency characteristics, which are the frequency characteristics C₂ of input/output gain and phase lag of the speed control unit 120 and/or the filter 130, which have been set in the pre-adjustment servo parameters, and the frequency characteristics C₁ of input/output gain and phase lag of the speed control unit 120 and/or the filter 130, which have been set in the post-adjustment servo parameters, by using the transfer function G_{V}(jω) of the speed control unit 120 and/or the transfer function G_{F}(jω) of the filter 130.

At step S14, the state estimation unit 404 reads, from the pre-adjustment state storing unit 402, the frequency characteristics P of input/output gain and phase lag, which have been acquired by allowing the servo control unit 100 to drive by using a speed command (a sinusoidal wave) that the frequency generation unit 200 outputs, based on the pre-adjustment servo parameters, uses the frequency characteristics C₁, the frequency characteristics C₂, and the frequency characteristics P, and acquires, with Mathematical Equation 3 (E=C₁−C₂+P), the estimation value E of frequency characteristics of input/output gain and phase lag of the servo control unit 100. At step S15, it is determined whether the processing to acquire the estimation value E of frequency characteristics should be continued. When it is determined to continue the processing, the flow returns to step S12. When it is determined to not continue the flow, the flow causes the control assist device to end its operation.

### Second Embodiment

In the first embodiment, the frequency characteristics measurement unit 300 has calculated, when measuring frequency characteristics of input/output gain (amplitude ratio) and phase lag of the servo control unit 100, frequency characteristics from a speed command, which represents a sinusoidal signal having a varying frequency, and a speed feedback. In the present embodiment, the frequency generation unit 200 inputs a sinusoidal signal, after the filter 130, while sequentially changing the frequency. Then, the frequency characteristics measurement unit 300 calculates, when measuring frequency characteristics of input/output gain and phase lag of the servo control unit 100, frequency characteristics from the sinusoidal signal that has been inputted after the filter 130, and from an output of the filter 130.

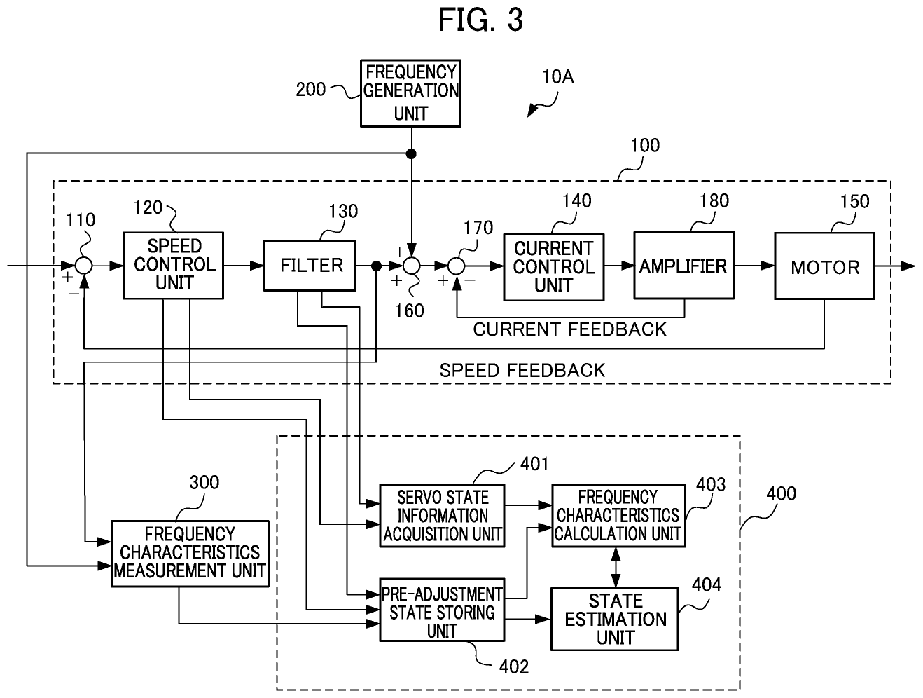

FIG. 3 is a block diagram illustrating a control device according to the second embodiment of the present disclosure.

In FIG. 3, like reference numerals designate identical components to the components of the control device 10 illustrated in FIG. 1, and duplicated descriptions are thus omitted. As illustrated in FIG. 3, a control device 10A is provided with an adder 160 at a subsequent stage of the filter 130. A sinusoidal signal having a varying frequency, which is outputted from the frequency generation unit 200, is inputted into this adder 160. A subtracter 170 is coupled to the adder 160. An amplifier 180 is coupled to the current control unit 140. The amplifier 180 includes a current detector. A current detected by the current detector is inputted into the subtracter 170. The subtracter 170, the current control unit 140, and the amplifier 180 configure a current feedback loop. The current feedback loop is included in a speed feedback loop. A sinusoidal signal corresponds to a first signal having a varying frequency. An output of the filter 130 corresponds to a second signal to be inputted into the current feedback loop in the speed feedback loop.

The inductance of the motor 150 is subject to magnetic saturation, for example, and changes in a non-linear manner due to the current flowing into the motor 150. When there is a change from the pre-adjustment servo parameters to the post-adjustment servo parameters, a torque command to be inputted into the current control unit 140 changes, and, when the current gain of the current control unit 140 is constant, the current flowing into the motor 150 also changes. When the current flowing into the motor 150 changes, and the inductance changes in a non-linear manner, the characteristics of the current feedback loop also change in a non-linear manner.

In the present embodiment, the level of an input signal to be inputted into the subtracter 110 is set to zero. The frequency generation unit 200 inputs a sinusoidal signal while sequentially changing the frequency after the filter 130. The frequency characteristics measurement unit 300 uses this sinusoidal signal and the output from the filter 130 to measure frequency characteristics of input/output gain and phase lag of the servo control unit 100. By doing so, an input into the current feedback loop becomes constant. Therefore, while maintaining the linearity of the characteristics of the current feedback loop, it is possible to estimate, with the control assist unit 400, frequency characteristics of input/output gain and phase lag of the servo control unit 100.

### Third Embodiment

In the first and second embodiments, it has been acquired estimation values of frequency characteristics of input/output gain (amplitude ratio) and phase lag of the servo control unit 100 in the post-adjustment servo parameters. In the present embodiment, a control device is described that acquires estimation values of frequency characteristics of input/output gain and phase lag of the servo control unit 100, and that uses this estimation value to acquire, through machine learning, an optimum value for each of the servo parameters of the servo control unit 100. In the below description, an example is described where a machine learning unit is added to the control device 10 illustrated in FIG. 1. However, the machine learning unit may be added to the control device 10A illustrated in FIG. 3.

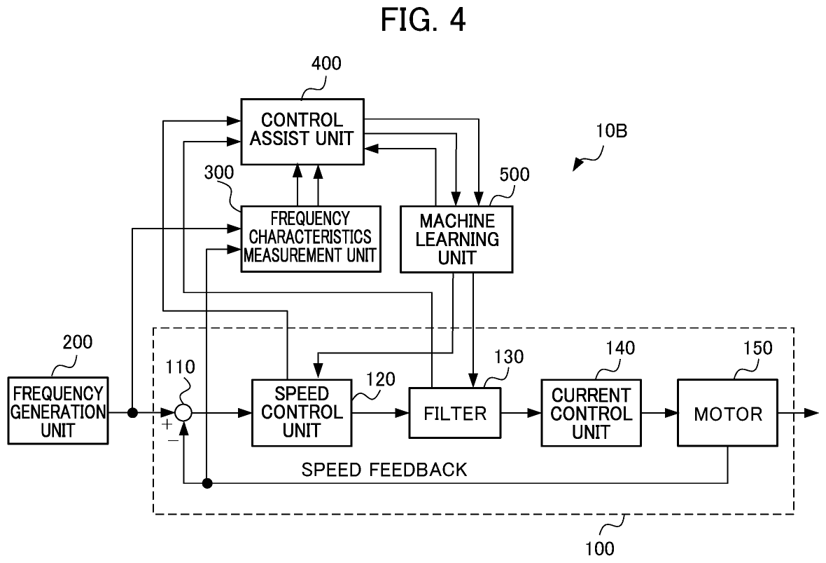

FIG. 4 is a block diagram illustrating the control device according to the third embodiment of the present disclosure. In FIG. 4, like reference numerals designate identical components to the components illustrated in FIG. 1, and duplicated descriptions are thus omitted. As illustrated in FIG. 4, a control device 10B has a configuration where a machine learning unit 500 serving as a machine learning device is added to the control device 10 illustrated in FIG. 1. The machine learning unit 500 is configured to acquire estimation values of input/output gain and phase lag of the servo control unit 100, which are outputted from the control assist unit 400, and to send adjustment information for the values of the servo parameters to the control assist unit 400. Then, the machine learning unit 500 performs machine learning (hereinafter “machine learning” will be referred to as “learning”) of optimum values for the servo parameters of the servo control unit 100 to allow estimation values of frequency characteristics of input/output gain and phase lag of the servo control unit 100 to fall within a range identical to that for target frequency characteristics or to fall within a constant range. Then, the machine learning unit 500 sets the optimum values to the servo parameters of the servo control unit 100, that is, to the integral gain K1v and the proportional gain K2v and each of the coefficients ω_{c}, τ, and δ of the transfer function of the filter 130. The learning by the machine learning unit 500 is performed before shipping. However, re-learning may be performed after shipping. For the learning that the machine learning unit 500 performs, it is possible to use reinforcement learning. However, the learning is not particularly limited to the reinforcement learning. For example, supervised learning may be performed.

Note that, in a case where the machine learning unit 500 performs learning of the servo parameters of the servo control unit 100, when the servo parameters of the servo control unit 100 have been adjusted, the servo control device has been operated each time of the adjustment, frequency characteristics of input/output gain and phase lag outputted from the frequency characteristics measurement unit 300 have been used, and learning of optimum values for the servo parameters of the servo control unit 100 is to be performed, it may be necessary to cause the servo control device to operate each time each of the servo parameters of the servo control unit 100 is adjusted and to cause the frequency characteristics measurement unit 300 to measure frequency characteristics of input/output gain and phase lag, requiring more time for processing. In the present embodiment, the machine learning unit 500 uses estimation values of frequency characteristics of input/output gain and phase lag, which is acquired by the control assist unit 400, to perform learning of optimum values for the servo parameters of the servo control unit 100. Therefore, it is possible to adjust the servo parameters in a simplified manner within a short period of time.

Machine learning that the machine learning unit 500 serving as the machine learning device performs will now be additionally described herein.

### <Machine Learning Unit 500>

In the below description, a case when the machine learning unit 500 performs reinforcement learning will be described. The machine learning unit 500 performs Q-learning where estimation values of input/output gain and phase lag, which are outputted from the control assist unit 400, are regarded as a state S, and adjustments to the values of the servo parameters in the control assist unit 400 under the state S are regarded as an action A. As is well known by those skilled in the art, the Q-learning aims to select, under a certain state S, an action A according to which a value Q(S, A) becomes highest as an optimum action among actions A that are possible to take.

Specifically, an agent (a machine learning device) selects an action A that varies under a certain state S to select a better action based on a reward provided to the action A at that time to perform learning of the correct value Q(S, A).

Furthermore, since the purpose is to maximize a total of rewards to be acquired in the future, what is aimed is to finally satisfy an equation of Q(S, A)=E[Σ(γ^{t})rₜ]. Where E[ ] represents an expected value, t represents time, γ represents a parameter called discount rate described later, rₜ represents a reward at the time t, and Σ represents a total at the time t. The expected value in this equation is an expected value when a state changes in accordance with an optimum action. It is possible to represent an updating expression for the value Q(S, A) as described above with Mathematical Equation 6 (hereinafter referred to as Equation 6) described below, for example.

$$Q ( {S}_{t + 1} , {A}_{t + 1} ) ← Q ( {S}_{t} , {A}_{t} ) + α ( {r}_{t + 1} + γ {max}_{A} Q ( {S}_{t + 1} , A ) - Q ( {S}_{t} , {A}_{t} ) ) \qquad [ Equation 6 ]$$

In Mathematical Equation 6 described above, Sₜ represents the state of an environment at the time t, and Aₜ represents an action at the time t. With the action Aₜ, the state changes to Sₜ₊₁. A reward to be acquired when the state changes is represented by rₜ₊₁. Furthermore, the item attached with max represents one acquired by multiplying a Q value by γ when selecting an action A according to which the Q value becomes highest, which is known at that time under the state Sₜ₊₁. Note herein that γ represents a parameter satisfying 0<γ≤1, and is called a discount rate. Furthermore, a represents a learning coefficient falling within a range of 0<α≤1.

Mathematical Equation 6 described above represents a method of updating a value Q(Sₜ, Aₜ) of the action Aₜ under the state Sₜ based on the reward rₜ₊₁ returned as a result of the attempt Aₜ.

The machine learning unit 500 observes state information S including estimation values of frequency characteristics of input/output gain and phase lag per frequency estimated by the control assist unit 400 to determine an action A. Each time the action A is performed, the machine learning unit 500 receives a reward. Rewards will be described later. In the Q-learning, the machine learning unit 500 searches in a trial-and-error manner for an optimum action A according to which a total of rewards to be acquired in the future is maximized, for example. By doing so, the machine learning unit 500 is able to select an optimum action A (i.e., an optimum value for a servo parameter) with respect to a state S.

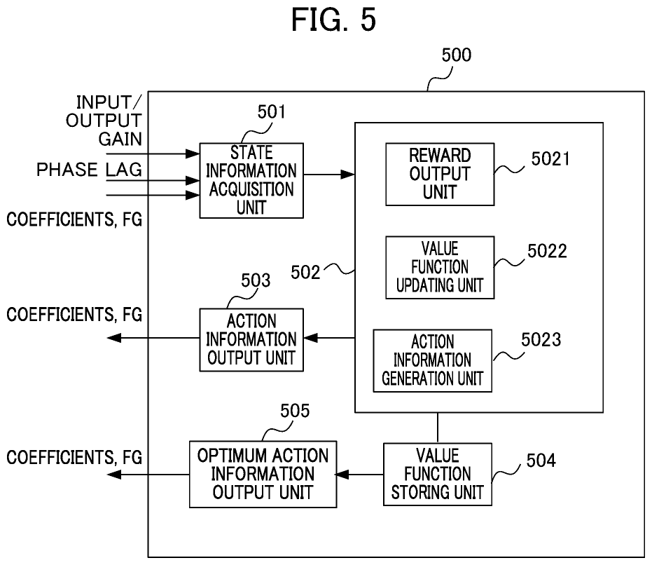

FIG. 5 is a block diagram illustrating the machine learning unit 500 according to the embodiment of the present invention. To perform the reinforcement learning described above, the machine learning unit 500 includes, as illustrated in FIG. 5, a state information acquisition unit 501, a learning unit 502, an action information output unit 503, a value function storing unit 504, and an optimum action information output unit 505.

The state information acquisition unit 501 is configured to acquire, from the control assist unit 400, estimation values of frequency characteristics of input/output gain and phase lag of the servo control unit 100, which is calculated by using the post-adjustment servo parameters, and to output the acquired estimation value to the learning unit 502. The state information acquisition unit 501 acquires, from the frequency characteristics measurement unit 300, at a point in time of starting the Q-learning for the first time, frequency characteristics of input/output gain and phase lag of the servo control unit 100 with the pre-adjustment servo parameters and outputs the acquired frequency characteristics to the learning unit 502. The estimation value of frequency characteristics, which is acquired from the control assist unit 400, serves as the state information S. The state information S corresponds to an environment state S for the Q-learning.

Note that, at the point in time of starting the Q-learning for the first time, the state information acquisition unit 501 acquires the pre-adjustment servo parameters each having an initial value from the speed control unit 120 and the filter 130 and outputs the acquired pre-adjustment servo parameters to the learning unit 502. As already described above, a user should generate beforehand the pre-adjustment servo parameters each having the initial value. For a servo parameter having an initial value, the initial value may be an adjusted value when an operator has made an adjustment on a machine tool beforehand.

The learning unit 502 is a part configured to perform learning of the value Q(S, A) when a certain action A is selected under a certain environment state S. The learning unit 502 includes a reward output unit 5021, a value function updating unit 5022, and an action information generation unit 5023.

The reward output unit 5021 is a part configured to calculate a reward when an action A is selected under a certain state S. The reward output unit 5021 compares, when a servo parameter having an initial value has been adjusted, an estimation value gs of input/output gain per frequency with a value gb of input/output gain per frequency of a reference model that has been set beforehand. The reward output unit 5021 provides a negative reward when the estimation value gs of input/output gain is greater than the value gb of input/output gain of the reference model. On the other hand, the reward output unit 5021 provides, when the estimation value gs of input/output gain is equal to or smaller than the value gb of input/output gain of the reference model, and when the state S has changed to a state S′, a positive reward when an estimation value of phase lag decreases, and provides a negative reward when the estimation value of phase lag increases, or provides a reward having a value of zero when the estimation value of phase lag does not change.

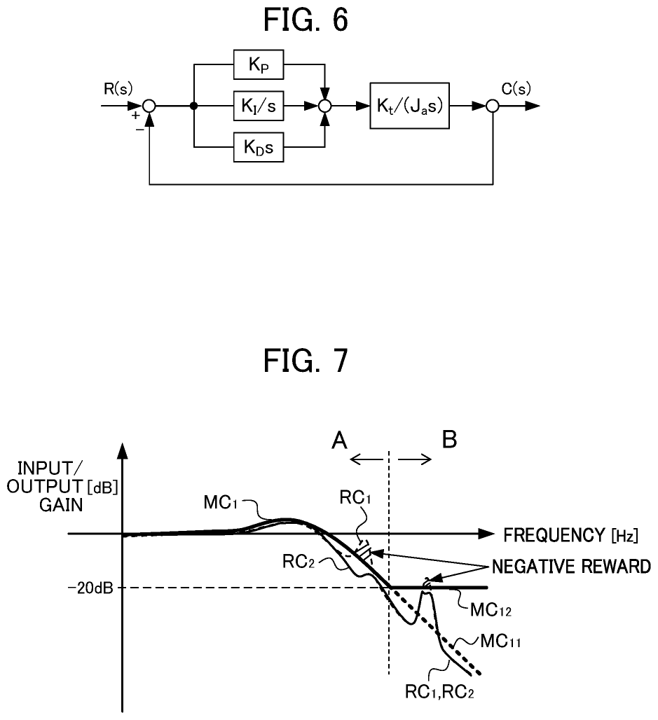

First of all, operation when the reward output unit 5021 provides a negative reward when the estimation value gs of input/output gain is greater than the value gb of input/output gain of the reference model will now be described herein with reference to FIGS. 6 and 7. The reward output unit 5021 stores the reference model of input/output gain. The reference model represents a model of a servo control unit, which has ideal characteristics that do not cause resonate to occur. It is possible to acquire a reference model through calculation using, for example, inertia Ja, a torque constant Kₜ, proportional gain Kₚ, integral gain K_{I}, and differential gain K_{D} of the model illustrated in FIG. 6. The inertia Ja represents a value acquired by adding motor inertia and mechanical inertia to each other. FIG. 7 is a characteristic diagram illustrating frequency characteristics of input/output gain of a servo control unit, according to the reference model, and frequency characteristics according to estimation values of input/output gain of the servo control unit 100 before learning and after learning. According to the characteristic diagram illustrated in FIG. 7, the reference model includes a region A representing a frequency region within which it is possible to acquire constant input/output gain or greater, that is, an ideal input/output gain of −20 dB or greater, for example, and a region B representing a frequency region within which it is possible to acquire input/output gain below the constant input/output gain. In the region A in FIG. 7, a curve MC₁ (bold line) illustrates the ideal input/output gain of the reference model. In the region B in FIG. 7, a curve MC₁₁ (broken bold line) illustrates ideal, virtual input/output gain of the reference model, and a straight line MC₁₂ (bold line) illustrates when the input/output gain of the reference model is set to a constant value. In the regions A and B in FIG. 7, curves RC₁, RC₂ respectively represent curves of estimation values of input/output gain of the servo control unit before learning and after learning.

The reward output unit 5021 provides, in the region A, a first negative reward when the curve RC₁ of the estimation value of input/output gain before learning exceeds the curve MC₁ of the ideal input/output gain of the reference model. In the region B within which the frequency exceeds one at which the input/output gain fully decreases, negative effects to the stability become smaller even when the curve RC₁ of the estimation value of input/output gain before learning exceeds the curve MC₁₁ of the ideal, virtual input/output gain of the reference model. Therefore, in the region B, as described above, the input/output gain of the reference model does not follow the curve MC₁₁ indicating ideal gain characteristics. Instead, the straight line MC₁₂ along which the input/output gain has the constant value (e.g., −20 dB) is used. However, when the curve RC₁ of the estimation value of input/output gain before learning exceeds the straight line MC₁₂ along which the input/output gain has the constant value, instability may arise. Therefore, a first negative value is provided as a reward.

Next, operation of the reward output unit 5021 for determining a reward based on an estimation value of phase lag when the estimation value gs of input/output gain is equal to or below the value gb of input/output gain of the reference model will now be described herein. In the below description, D(S) represents an estimation value of phase lag, which is a state variable pertaining to the state information S, and D(S′) represents an estimation value of phase lag, which is a state variable pertaining to the state S′ that has been changed from the state S due to the action information A (adjustment in value of servo parameter). Note that, since, at a point in time of starting the Q-learning for the first time, no estimation value of phase lag is acquired, the phase lag of the servo control unit 100, which has been acquired by allowing the servo control unit 100 to operate with the servo parameters each having the initial value, which has been acquired from the frequency characteristics measurement unit 300, is regarded as D(S) to determine rewards described below.

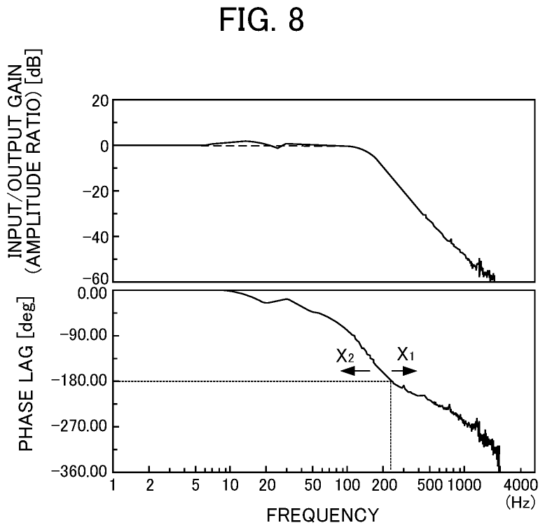

The methods described below are example methods with which the reward output unit 5021 determines a reward based on an estimation value of phase lag. When the state S has changed to the state S′, it is possible to determine a reward depending on whether a frequency at which an estimation value of phase lag reaches 180 degrees increases, decreases, or remains constant. Note herein that, although the case where an estimation value of phase lag reaches 180 degrees has been described, the value is not particularly limited to 180 degrees, and other values may be used. For example, in a case where an estimation value of phase lag is indicated in a phase plot illustrated in FIG. 8, when the state S has changed to the state S′ and the curve has changed (in an X₂ direction in FIG. 8) to allow a frequency at which the estimation value of phase lag reaches 180 degrees to decrease, the estimation value of phase lag increases. On the other hand, when the state S has changed to the state S′ and the curve has changed (in an X₁ direction in FIG. 8) to allow the frequency at which the estimation value of phase lag reaches 180 degrees to increase, the estimation value of phase lag decreases.

Therefore, when the state S has changed to the state S′ and the frequency at which the estimation value of phase lag reaches 180 degrees has decreased, it is defined that the estimation value D(S) of phase lag < the estimation value D(S′) of phase lag, and the reward output unit 5021 sets a value of reward to a second negative value. Note that an absolute value of the second negative value is set to a value smaller than that of the first negative value. On the other hand, when the state S has changed to the state S′ and the frequency at which the estimation value of phase lag reaches 180 degrees has increased, it is defined that the estimation value D(S) of phase lag > the estimation value D(S′) of phase lag, and the reward output unit 5021 sets a value of reward to a positive value. Furthermore, when the state S has changed to the state S′ and the frequency at which the estimation value of phase lag reaches 180 degrees has not yet changed, it is defined that the estimation value D(S) of phase lag=the estimation value D(S′) of phase lag, and the reward output unit 5021 sets a value of reward to a value of zero.

A method of determining a reward based on an estimation value of phase lag is not limited to the method described above. Such a method may be used that, when the state S has changed to the state S′ and a phase margin has decreased, a reward having the second negative value may be provided, when the phase margin has increased, a reward having a positive value may be provided, and, when the phase margin has remained constant, a reward having a value of zero may be provided.

The reward output unit 5021 has been described above.

The value function updating unit 5022 is configured to perform the Q-learning based on the state S, the action A, the state S′ when the action A is applied to the state S, and a reward acquired as described above to update the value function Q that the value function storing unit 504 stores. For updating the value function Q, online learning, batch learning, or mini-batch learning may be performed. The online learning refers to a learning method under which a certain action A is applied to a present state S to immediately update the value function Q each time the state S has transitioned to a new state S′. Furthermore, the batch learning refers to a learning method under which a certain action A is applied to the present state S and the state S is allowed to repeatedly transition to a new state S′ to collect data used for learning, use all pieces of collected data used for learning, and update the value function Q. Furthermore, the mini-batch learning serves as intermediate learning between the online learning and the batch learning, and refers to a learning method under which, each time data used for learning is cumulated to a certain level, the value function Q is updated.

The action information generation unit 5023 is configured to select an action A for the present state S in the course of the Q-learning. The action information generation unit 5023 generates action information A to cause operation of adjusting the value of a servo parameter (corresponding to an action A in the Q-learning) to be performed, in the course of the Q-learning, and outputs the generated action information A to the action information output unit 503. More specifically, the action information generation unit 5023 may perform an addition or a subtraction in an incremental manner, for example, for the integral gain K1v and the proportional gain K2v of the speed control unit 120 and each of the coefficients ω_{c}, τ, and δ of the transfer function of the filter 130, in the servo parameters, which are included in an action A for the post-adjustment servo parameters, which are included in the state S.

Note that the integral gain K1v and the proportional gain K2v of the speed control unit 120 and each of the coefficients ω_{c}, τ, and δ of the filter 130, which serve as the servo parameters, may all be modified, or only some coefficients may be modified. When each of the coefficients ac, T, and 6 of the filter 130 is adjusted, for example, it is possible to easily find the center frequency fc that causes resonance to occur, that is, it is possible to easily identify the center frequency fc. Then, to perform operation of temporarily fixing the center frequency fc and modifying the bandwidth fw and the attenuation coefficient δ, that is, fixing the coefficient ω_{c} (=2πfc) and modifying the coefficient τ (=fw/fc) and the attenuation coefficient δ, the action information generation unit 5023 may generate the action information A and output the generated action information A to the action information output unit 503.

Furthermore, the action information generation unit 5023 may use a commonly known method such as the greedy algorithm that selects an action A′ according to which the value Q(S, A) becomes highest and the e-greedy algorithm that selects an action A′ at random at a certain small probability ε and that selects the action A′ according to which the value Q(S, A) becomes highest at other than the certain small probability ε, among the values of the presently conceivable actions A, to take such a measure that selects an action A′.

The action information output unit 503 is configured to send the action information A outputted from the learning unit 502 to the control assist unit 400. As described above, by adjusting the integral gain K1v and the proportional gain K2v of the speed control unit 120 and/or each of the coefficients ω_{c}, τ, and δ, which have been set presently, in the servo parameters, in a present state S, that is, in the control assist unit 400, based on this action information, there is a transition to a next state S′ (i.e., the integral gain K1v and the proportional gain K2v of the speed control unit 120 and/or each of the coefficients of the filter 130, which have been adjusted).

The value function storing unit 504 is a storage device configured to store the value function Q. The value function Q may be stored as a table (hereinafter referred to as action value table) per state S or action A, for example. The value function Q stored in the value function storing unit 504 is updated by the value function updating unit 5022. Furthermore, the value function Q stored in the value function storing unit 504 may be shared with another machine learning unit 500. By allowing the value function Q to be shared among a plurality of the machine learning units 500, it is possible to perform reinforcement learning in a distributed manner among the machine learning units 500, improving the efficiency of the reinforcement learning.

The optimum action information output unit 505 is configured to generate, based on the value function Q, which is updated as the value function updating unit 5022 performs the Q-learning, action information A (hereinafter referred to as “optimum action information”) causing the speed control unit 120 and the filter 130 to perform operation according to which the value Q(S, A) becomes maximum. More specifically, the optimum action information output unit 505 acquires the value function Q that the value function storing unit 504 stores. This value function Q is one that is updated as the value function updating unit 5022 performs the Q-learning, as described above. Then, the optimum action information output unit 505 generates action information based on the value function Q, and outputs the generated action information to the speed control unit 120 and/or the filter 130 of the servo control unit 100. This optimum action information includes information of modifying the integral gain K1v and the proportional gain K2v of the speed control unit 120 and/or each of the coefficients ω_{c}, τ, and δ of the transfer function of the filter 130 of the servo control unit 100.

In the speed control unit 120, the integral gain K1v and the proportional gain K2v are modified based on this action information. In the filter 130, each of the coefficients c), T, and 5 of the transfer function is modified based on this action information. With the operation described above, the machine learning unit 500 is able to operate to optimize the servo parameters and suppress vibrations at an end of a machine. Furthermore, it is possible to simplify adjusting of the servo parameters.

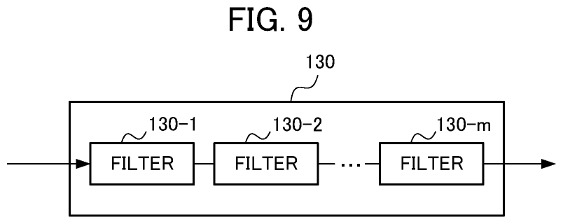

In the embodiments described above, described are cases where one filter is provided. However, for the filter 130, a plurality of filters respectively correspond to different frequency bands may be configured to be coupled to each other in series. FIG. 9 is a block diagram illustrating an example when configuring a filter by directly coupling a plurality of filters to each other. In FIG. 9, when there are the m number (m is a natural number of 2 or greater) of resonance points, the filter 130 is configured by coupling the m number of filters 130-1 to 130-m to each other in series.

Furthermore, for the configuration of the control device, there are configurations described below in addition to the configurations illustrated in FIGS. 1, 3, and 4.

<Modification Examples when Control Assist Unit is Coupled to Servo Control Unit Via Network>

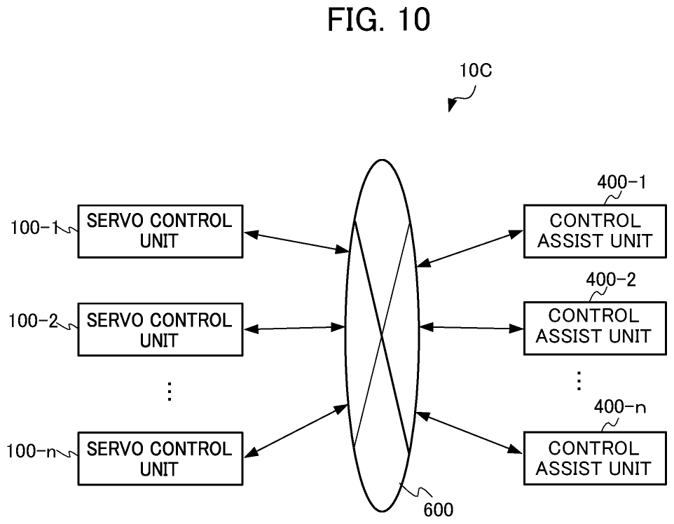

FIG. 10 is a block diagram illustrating another configuration example of a control device. Differences in a control device 10C illustrated in FIG. 10 from the control devices 10 illustrated in FIG. 1 or 3 are that the n number (n is a natural number of 2 or greater) of servo control units 100-1 to 100-n are respectively coupled, via a network 600, to the n number of control assist units 400-1 to 400-n and each include the frequency generation unit 200 and the frequency characteristics measurement unit 300. The control assist units 400-1 to 400-n each have a configuration identical to that of the control assist unit 400 illustrated in FIG. 1. The servo control units 100-1 to 100-n each correspond to a servo control device, and the control assist units 400-1 to 400-n each correspond to a control assist device. Note that it is obvious that either or both of the frequency generation unit 200 and the frequency characteristics measurement unit 300 may be provided outside the servo control units 100-1 to 100-n. The configuration illustrated in FIG. 10 may be applied to the control device 10B illustrated in FIG. 4. In that case, the servo control units 100-1 to 100-n each include the machine learning unit 500. Note that it is obvious that the machine learning unit 500 may be provided outside the servo control units 100-1 to 100-n.

Note herein that the servo control unit 100-1 and the control assist unit 400-1 form a pair one by one, and are communicably coupled to each other. The servo control units 100-2 to 100-n and the control assist units 400-2 to 400-n are respectively coupled to each other, similar to the servo control unit 100-1 and the control assist unit 400-1. In FIG. 10, the n number of pairs of the servo control units 100-1 to 100-n and the control assist units 400-1 to 400-n are coupled to each other via the network 600. However, for the n number of pairs of the servo control units 100-1 to 100-n and the control assist units 400-1 to 400-n, the pairs of the servo control units and the control assist units may be respectively directly coupled to each other via a coupling interface. For these n number of pairs of the servo control units 100-1 to 100-n and the control assist units 400-1 to 400-n, for example, a plurality of pairs may be installed in a single factory or may be respectively installed in different factories.

Note that the network 600 is, for example, a local area network (LAN) constructed in a factory, the Internet, a public telephone network, or a combination thereof. For the network 600, its communication method is not particularly limited to a specific communication method. Whether wired connections or wireless connections are used is also not particularly limited, for example.

### <Degree of Freedom in System Configuration>

In the embodiments described above, each of the servo control units 100-1 to 100-n and each of the control assist units 400-1 to 400-n form a pair one by one and are communicably coupled to each other. However, for example, one control assist unit may be communicably coupled to a plurality of servo control units via the network 600 to implement control assistance for each of the servo control units. At that time, there may be a distributed processing system in which the functions of the one control assist unit are appropriately distributed among a plurality of servers. Furthermore, a virtual server function that is available on a cloud may be utilized to achieve the functions of the one control assist unit.

Furthermore, when there are the n number of the servo control units 100-1 to 100-n and the n number of the respectively corresponding control assist units 400-1 to 400-n, which are respectively identical to each other in type name, specifications, and series, such a configuration may be applied that the control assist units 400-1 to 400-n share their respective estimation results. By doing so, it is possible to configure a more optimum model.

The first, second, and third embodiments have been described above. It is possible to achieve the components included in the control devices according to the embodiments, in the form of hardware, software, or a combination thereof. Furthermore, it is possible to achieve a servo control method to be performed through cooperation with each other of the components included in the control devices described above, in the form of hardware, software, or a combination thereof. In here, achievement through software means achievement when a computer reads and executes a program.

It is possible to use a non-transitory computer readable medium that varies in type to store the program, and to supply the program to a computer. Examples of the non-transitory computer readable medium include tangible storage media that vary in type. Examples of the non-transitory computer readable medium include magnetic recording media (for example, hard disk drive), magneto-optical recording media (for example, magneto-optical disc), compact disc read only memories (CD-ROM), compact disc-recordable (CD-R), compact disc-rewritable (CD-R/W), semiconductor memories (for example, mask ROM, programmable ROM (PROM), erasable PROM (EPROM), flash ROM, and random access memory (RAM)). Furthermore, the program may be supplied to the computer via a transitory computer readable medium that varies in type.

Although the foregoing embodiments represent preferable embodiments of the present invention, the scope of the present invention should not be limited to only the embodiments described above. Embodiments that have been variously changed without departing from the gist of the present invention are also implementable.

It is possible that the control assist device, the control device, and the control assist method according to the present disclosure take various types of embodiments having configurations described below, including the embodiments described above.

(1) A control assist device (e.g., the control assist unit 400) configured to provide assistance for performing an adjustment of at least either of at least one coefficient of a filter (e.g., the filter 130) and feedback gain of a servo control device (e.g., the servo control unit 100) configured to control a motor (e.g., the motor 150). The control assist device includes:

a servo state information acquisition unit (e.g., the servo state information acquisition unit 401) configured to acquire first information including at least either of the at least one coefficient of the filter and the feedback gain after the adjustment;
a frequency characteristics calculation unit (e.g., the frequency characteristics calculation unit 403) configured to use second information including at least either of the at least one coefficient of the filter and the feedback gain before the adjustment and the first information and to calculate at least one of frequency characteristics among frequency characteristics of input/output gain and phase lag of the filter and frequency characteristics of input/output gain and phase lag of the feedback gain before and after the adjustment of the coefficient of the filter and the feedback gain (e.g., the speed control unit 120); and
a state estimation unit (e.g., the state estimation unit 404) configured to acquire, based on the at least one of frequency characteristics before and after the adjustment and measured frequency characteristics of input/output gain and phase lag in input/output of the servo control device before the adjustment of at least either of the coefficient of the filter and the feedback gain, estimation values of the frequency characteristics of input/output gain and phase lag of the servo control device after the adjustment of at least either of the coefficient of the filter and the feedback gain.

With this control assist device, when adjusting at least either of at least one coefficient of the filter and feedback gain of the servo control device, it is possible to acquire frequency characteristics of input/output gain and phase lag without acquiring frequency characteristics of input/output gain and phase lag by allowing the servo control device to operate each time adjusting at least either of at least one coefficient of the filter and feedback gain. Therefore, it is possible to shorten the period of time it takes to measure frequency characteristics of input/output gain and phase lag.

(2) The control assist device described above in (1) further includes a pre-adjustment state information storing unit (e.g., the pre-adjustment state storing unit 402) configured to store the measured frequency characteristics of input/output gain and phase lag in input/output of the servo control device and the second information.

(3) A control device includes:

a servo control device configured to control a motor; and the control assist device described above in (1) or (2) configured to acquire estimation values of the frequency characteristics of input/output gain and phase lag of the servo control device after adjustment of at least either of at least one coefficient of the filter and the feedback gain of the servo control device.

With this control device, when adjusting at least either of at least one coefficient of the filter and feedback gain of the servo control device, it is possible to acquire frequency characteristics of input/output gain and phase lag without acquiring frequency characteristics of input/output gain and phase lag by allowing the servo control device to operate each time adjusting at least either of at least one coefficient of the filter and feedback gain. Therefore, it is possible to shorten the period of time it takes to measure frequency characteristics of input/output gain and phase lag.

(4) The control device described above in (3) includes a machine learning device (e.g., the machine learning unit 500) configured to optimize, based on the estimation value of the frequency characteristics of input/output gain and phase lag of the servo control device, which is acquired by the control assist device described above in (1) or (2), at least either of the at least one coefficient and the feedback gain of the filter of the servo control device. With this control device, it is possible to adjust a parameter for the speed control unit and/or the filter in a simplified manner within a short period of time.

(5) The control device described above in (3) or (4) includes:

a frequency generation device configured to generate a signal having a varying frequency and to input the signal into the servo control device; and
a frequency characteristics measurement unit configured to measure frequency characteristics of input/output gain and phase lag of the servo control device based on the signal and an output signal of the servo control device.

(6) The control device described above in (3) or (4), in which the servo control device includes a current feedback loop used to control a current flowing into the motor and a feedback loop including the current feedback loop and having the filter and the feedback gain, includes:

a frequency generation device configured to generate a first signal having a varying frequency and to input the first signal into the current feedback loop; and
a frequency characteristics measurement unit configured to measure, based on the first signal and a second signal to be inputted into the current feedback loop in the feedback loop, frequency characteristics of input/output gain and phase lag of the servo control device.

(7) A control assist method for a control assist device (e.g., the control assist unit 400) configured to provide assistance for performing an adjustment of at least either of at least one coefficient of a filter (e.g., the filter 130) and feedback gain of a servo control device (e.g., the servo control unit 100) configured to control a motor (e.g., the motor 150). The control assist method includes:

acquiring first information including at least either of the at least one coefficient of the filter and the feedback gain after the adjustment and second information including at least either of the at least one coefficient of the filter and the feedback gain before the adjustment;
using the second information and the first information to calculate at least one of frequency characteristics among frequency characteristics of input/output gain and phase lag of the filter and frequency characteristics of input/output gain and phase lag of the feedback gain (e.g., the speed control unit 120) before and after the adjustment of at least either of the coefficient of the filter and the feedback gain; and
acquiring, based on the at least one of frequency characteristics before and after the adjustment and measured frequency characteristics of input/output gain and phase lag in input/output of the servo control device before the adjustment of at least either of the coefficient of the filter and the feedback gain, estimation values of the frequency characteristics of input/output gain and phase lag of the servo control device after the adjustment of at least either of the coefficient of the filter and the feedback gain.

With this control assist method, when adjusting at least either of at least one coefficient of the filter and feedback gain of the servo control device, it is possible to acquire frequency characteristics of input/output gain and phase lag without acquiring frequency characteristics of input/output gain and phase lag by allowing the servo control device to operate each time adjusting at least either of at least one coefficient of the filter and feedback gain. Therefore, it is possible to shorten the period of time it takes to measure frequency characteristics of input/output gain and phase lag.

### EXPLANATION OF REFERENCE NUMERALS

10, 10A Control device
100, 100-1 to 100-n Servo control unit
110 Subtracter
120 Speed control unit
130 Filter
140 Current control unit
150 Motor
200 Frequency generation unit
300 Frequency characteristics measurement unit
400, 400-1 to 400-n Control assist unit
401 Servo state information acquisition unit
402 Pre-adjustment state storing unit
403 Frequency characteristics measurement unit
404 State estimation unit
500 Machine learning unit
501 State information acquisition unit
502 Learning unit
503 Action information output unit
504 Value function storing unit
505 Optimum action information output unit
600 Network

1. A control assist device configured to provide assistance for performing an adjustment of at least either of at least one coefficient of a filter and feedback gain of a servo control device configured to control a motor, the control assist device comprising:
a servo state information acquisition unit configured to acquire first information including at least either of the at least one coefficient of the filter and the feedback gain after the adjustment;
a frequency characteristics calculation unit configured to use second information including at least either of the at least one coefficient of the filter and the feedback gain before the adjustment and the first information and to calculate at least one of frequency characteristics among frequency characteristics of input/output gain and phase lag of the filter and frequency characteristics of input/output gain and phase lag of the feedback gain before and after the adjustment of the coefficient of the filter and the feedback gain; and
a state estimation unit configured to acquire, based on the at least one of frequency characteristics before and after the adjustment and measured frequency characteristics of input/output gain and phase lag in input/output of the servo control device before the adjustment of at least either of the coefficient of the filter and the feedback gain, estimation values of the frequency characteristics of input/output gain and phase lag of the servo control device after the adjustment of at least either of the coefficient of the filter and the feedback gain.

2. The control assist device according to claim 1, further comprising a pre-adjustment state information storing unit configured to store the measured frequency characteristics of input/output gain and phase lag in input/output of the servo control device and the second information.

3. A control device comprising:
a servo control device configured to control a motor; and
the control assist device according to claim 1 configured to acquire estimation values of the frequency characteristics of input/output gain and phase lag of the servo control device after adjustment of at least either of at least one coefficient of the filter and the feedback gain of the servo control device.

4. The control device according to claim 3, further comprising a machine learning device configured to optimize, based on the estimation value of the frequency characteristics of input/output gain and phase lag of the servo control device, the estimation value being acquired by the control assist device, at least either of the at least one coefficient and the feedback gain of the filter of the servo control device.

5. The control device according to claim 3, further comprising:
a frequency generation device configured to generate a signal having a varying frequency and to input the signal into the servo control device; and
a frequency characteristics measurement unit configured to measure frequency characteristics of input/output gain and phase lag of the servo control device based on the signal and an output signal of the servo control device.

6. The control device according to claim 3,
wherein the servo control device includes a current feedback loop used to control a current flowing into the motor and a feedback loop including the current feedback loop and having the filter and the feedback gain, and
further comprising:
a frequency generation device configured to generate a first signal having a varying frequency and to input the first signal into the current feedback loop; and
a frequency characteristics measurement unit configured to measure, based on the first signal and a second signal to be inputted into the current feedback loop in the feedback loop, frequency characteristics of input/output gain and phase lag of the servo control device.

7. A control assist method for a control assist device configured to provide assistance for performing an adjustment of at least either of at least one coefficient of a filter and feedback gain of a servo control device configured to control a motor, the control assist method comprising:
acquiring first information including at least either of the at least one coefficient of the filter and the feedback gain after the adjustment and second information including at least either of the at least one coefficient of the filter and the feedback gain before the adjustment;
using the second information and the first information to calculate at least one of frequency characteristics among frequency characteristics of input/output gain and phase lag of the filter and frequency characteristics of input/output gain and phase lag of the feedback gain before and after the adjustment of at least either of the coefficient of the filter and the feedback gain; and
acquiring, based on the at least one of frequency characteristics before and after the adjustment and measured frequency characteristics of input/output gain and phase lag in input/output of the servo control device before the adjustment of at least either of the coefficient and the feedback gain, estimation values of the frequency characteristics of input/output gain and phase lag of the servo control device after the adjustment of at least either of the coefficient of the filter and the feedback gain.
